(19) United States
(12) Patent Application Publication
(10) Pub. No.: US 2013/0036154 A1
(43) Pub. Date: Feb. 7, 2013

(54) INTELLIGENT CONTENT DELIVERY

(71) Applicants: MAHESH KUMAR CHHAPARIA, Hyderabad (IN); Soumyadeb Mitra, Kolkata (IN)

(72) Inventors: MAHESH KUMAR CHHAPARIA, Hyderabad (IN); Soumyadeb Mitra, Kolkata (IN)

(21) Appl. No.: 13/249,666

(22) Filed: Sep. 30, 2011

(30) Foreign Application Priority Data
Aug. 5, 2011 (IN) 1039/KOL/2011

(51) Int. Cl. G06F 15/16

(52) U.S. Cl. 709/202

(57) ABSTRACT

A method includes bidirectionally intercepting data associated with content delivery from a content server to a client device through an agent executing on a central computing platform and/or the client device. The agent is capable of handling both secure and non-secure communication protocols. The method also includes performing, on the data intercepted, an action on behalf of a user of the client device through the agent such that a requirement of intervention of both the content server and an interface associated with the user of the client device therefor is dispensed with.

### CLAIM OF PRIORITY

This is a US utility application and claims priority from Indian Application Number 1039/KOL/2011 titled “INTELLIGENT CONTENT DELIVERY” filed on Aug. 5, 2011.

### FIELD OF TECHNOLOGY

This disclosure relates generally to content delivery systems and, more particularly, to a method, an apparatus and/or a system of intelligent content delivery.

### BACKGROUND

A content delivery system may involve a client device seeking content (e.g., resources) from a content server (e.g., web-server). For example, a user of the client device may load a web-page associated with a web-server on a browser therein. A proxy server (e.g., a web proxy) may serve as an intermediary between the client device and the content server. The proxy server may serve the request from the client device through caching the response(s) from the content server and transmitting the requisite content therefrom.

In the aforementioned example, when the user requires to perform an action (e.g., add a search box) on the web-page loaded on the browser, the user may have to write script therefor and/or utilize a browser extension. In another example where the user bookmarks the web-page on a specific browser (e.g., Google Chrome™), the web-page is indexed/saved in a list of bookmarks in an appropriate repository associated with the specific browser. When the user utilizes another browser (e.g., Microsoft®'s Internet Explorer®), the bookmarked page may not be available in the bookmark repository associated with the new browser. Therefore, scenarios analogous to the aforementioned examples may require the intervention of the user for the addition of “intelligence” to content from a content server, which may prove to be tedious.

### SUMMARY

Disclosed are a method, an apparatus and/or a system of intelligent content delivery.

In one aspect, a method includes bidirectionally intercepting data associated with content delivery from a content server to a client device through an agent executing on a central computing platform and/or the client device. The agent is capable of handling both secure and non-secure communication protocols. The method also includes performing, on the data intercepted, an action on behalf of a user of the client device through the agent such that a requirement of intervention of both the content server and an interface associated with the user of the client device therefor is dispensed with.

In another aspect, a medium, readable through a computing device and/or a central computing platform and including instructions embodied therein that are executable on the computing device and/or the central computing platform, includes instructions relating to bidirectionally intercepting data associated with content delivery from a content server to the client device. The medium also includes instructions associated with performing, on the data intercepted, an action on behalf of a user of the client device such that a requirement of intervention of both the content server and an interface associated with the user of the client device therefor is dispensed with. The instructions relating to intercepting the data associated with content delivery and the instructions relating to the performance of the action are configured to handle both secure and non-secure communication protocols.

In yet another aspect, a system includes a client device, a computer network, and a content server configured to deliver content to the client device through the computer network. The system also includes an agent configured to bidirectionally intercept data associated with the content delivery from the content server to the client device through the computer network, and to perform an action on behalf of a user of the client device such that a requirement of both the content server and an interface associated with the user of the client device therefor is dispensed with. The agent is capable of handling both secure and non-secure communication protocols.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of an intelligent content delivery system, according to one or more embodiments.

FIG. 2 is a schematic view of an agent-hosting central server of the intelligent content delivery system of FIG. 1 having an end-user data processing device associated therewith, according to one or more embodiments.

FIG. 3 is a schematic view of an architecture of an agent of FIG. 1 or FIG. 2, according to one or more embodiments.

FIG. 4 is a schematic view of processing of content from a data processing device through the agent of FIG. 1, according to one or more embodiments.

FIG. 5 is a process flow diagram detailing the operations involved in a method of intelligent content delivery, according to one or more embodiments.

### DETAILED DESCRIPTION

Example embodiments, as described below, may be directed to a method, an apparatus and/or a system of intelligent content delivery. Although the present embodiments have been described with reference to specific example embodiments, it will be evident that various modifications and changes may be made to these embodiments without departing from the broader spirit and scope of the various embodiments.

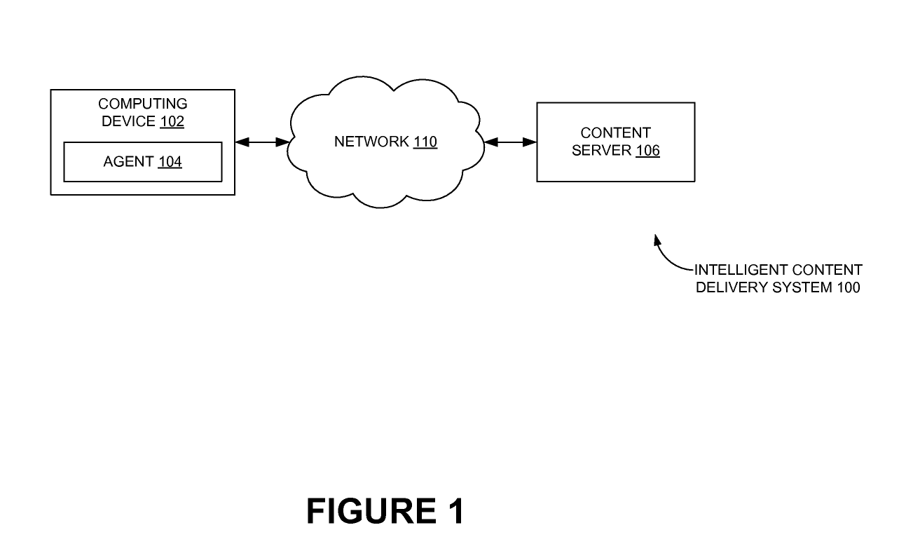

FIG. 1 shows an intelligent content delivery system 100, according to one or more embodiments. In one or more embodiments, intelligent content delivery system 100 may include a computing device 102 on which an agent 104 is configured to execute. For example, agent 104 may be installed on computing device 102 through a download (e.g., licensed download) from the Internet and/or from a computer readable-medium such as a compact disc (CD). Other forms of installation (e.g., through a Digital Video Disc (DVD), a Blu-ray™ disc, a floppy disk, a diskette, download and save on a memory such as a hard disk) are within the scope of the exemplary embodiments discussed herein. In one or more embodiments agent 104 may include a software engine and/or user interface(s) associated therewith. In one or more embodiments, intelligent content delivery system 100 may include a content server 106 (e.g., a web server) from which content (e.g., data) may be delivered to computing device 102.

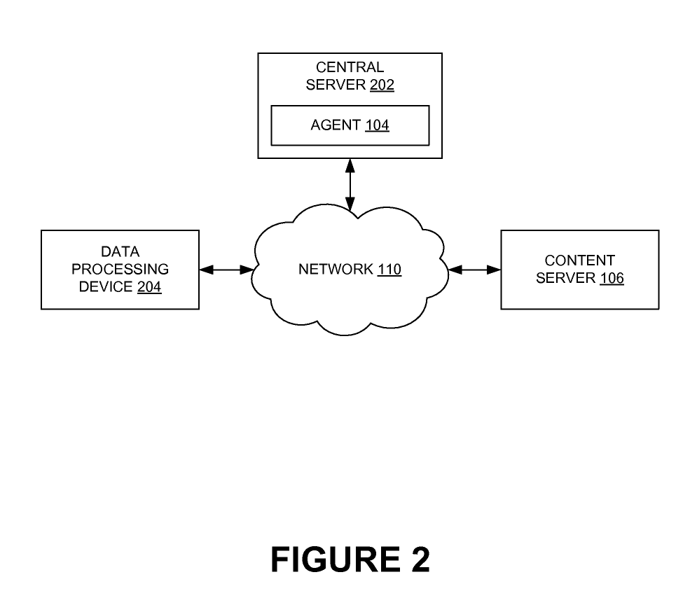

In one or more embodiments, computing device 102 may be an end-user data processing device. Alternately, in one or more embodiments, computing device 102 may be a central server of intelligent content delivery system 100 configured to deliver content to an end-user data processing device. FIG. 2 shows the aforementioned scenario where computing device 102 is central server 202 having an end-user data processing device 204 associated therewith. In one or more embodiments, agent 104 may serve as an intermediary (as will be discussed below) between content server 106 and the end-user. In one or more embodiments, agent 104 may implement the same protocol as would be used for normal communication between the end-user data processing device and content server 106.

For example, in the case of a substitute scenario of the end-user data processing device and content server 106 being configured to communicate through a Hypertext Transfer Protocol (HTTP), agent 104 may be configured to be able to intercept HTTP packets, parse the HTTP packets (e.g., header of the packet(s), body of the packet(s)), and create HTTP packets in accordance with the requirements of the end-user. In the case of the HTTP Secure (HTTPS) protocol, agent 104 may, again, be configured to be able to intercept the HTTPS session such that the raw packet data may be parsed in a manner similar to that of the aforementioned processing with regard to the HTTP packets.

Thus, in one or more embodiments, agent 104 may add the necessary “intelligence” to the content delivery/processing as required/desired by the end-user. For example, in the case of web-browser applications, agent 104 may serve as the intermediary between the end-user browser (an example of an interface associated with the user of computing device 102) and content server 106. Agent 104 may be configured to embed enhanced end-user functionality within a web page or a web application (e.g., served over content server 106 functioning as a web server) transparently without the intervention of content server 106 or the end-user browser.

For example, upon intercepting packets from content server 106 intended for the end-user browser, agent 104 may enable exposure of actions to the end-user beyond the capabilities of the web-page and/or the web application to be accessed thereby. In one instance, agent 104 may be configured to automatically insert Hypertext Markup Language (HTML) elements and/or JavaScript® to the web-page to be accessed by the end-user. The aforementioned actions may be web-page context dependent.

Thus, agent 104 may enable a uniform experience across different websites for the functions preferred/desired by the end-user and/or subscribed to/enabled by the end-user. For example, the end-user may configure agent 104 to embed JavaScript® and/or HTML elements within a web-page such that the web-page is enabled with a search box therein. In the aforementioned example, search may be natively available within the end-user browser. Therefore, other interesting functions unavailable natively within the end-user browser are also within the scope of the exemplary embodiments.

Bookmarking may be browser-specific. For example, when multiple web-browsers (e.g., Microsoft®'s Internet Explorer®, Google Chrome™) are employed on the same computing device, the bookmarks associated with each of the browsers may be saved in separate repositories associated therewith. However, through the user of agent 104, a common bookmarking functionality may be provided across all browsers in the computing device such that the bookmark data may be saved on a common store.

In one or more embodiments, agent 104 may provide a perception to the end-user that the embedded set of instructions (e.g., software code) associated with the enhanced functionality/“intelligence” provided therethrough is actually provided through content server 106. Thus, in the example discussed above, the end-user, having authorized agent 104 to embed the search box within the web-page, may be made aware of the success of the operation upon viewing the web-page and noticing the search box embedded therein. In the case of the Internet being disconnected and/or agent 104 being shut down (or, rendered inactive), the search box within the web-page may still be functional if the web-page is saved. However, the function associated with the bookmarking capability may require the “active” state of agent 104 to save the bookmark(s) to the common store. Thus, certain standalone functions may work despite the inactive state of agent 104 and certain other functions may require interaction with agent 104.

With regard to FIG. 2, exemplary embodiments may be directed to enterprise application(s). Here, agent 104 may be hosted centrally on a computer appliance residing on a platform and/or on a computing device having software associated with agent 104 installed thereon. Thus, in one or more embodiments, central server 202 may also be a computer appliance instead of a computing device. To generalize, central server 202 may be a computing platform (e.g., computer appliance, computing device). In the enterprise scenario, all web-pages may be routed through agent 104. For example, computer users in an organization may be performing Internet searches/Internet browsing behind a firewall installed by the system administrator. Unsafe content may also be transmitted through the Internet. Thus, here, agent 104 at central server 202 may also be configured to insert a tag to the content and/or a display indicator, which may become part of the web-page content rendered on the end-user browser.

In another example scenario, the end-user may repeatedly access a web-page to enter login details therein in order to access data associated therewith. Agent 104 may simplify the process by automatically entering the login details (e.g., username, password) to enable the end-user to automatically access the data associated therewith. Here, agent 104 may capture data packets associated with the login process directed to content server 106 to add intelligence to the login process. Thus, intelligence to content delivery to/from content server 106 may be added through agent 104 based on parameters such as frequency of access and preferences associated with the end-user.

It is obvious that data packets associated with the login process may be directed from the computing device/data processing device associated with the end-user to content server 106. Therefore, in one or more embodiments, agent 104 may bidirectionally (e.g., packets from content server 106, packets to content server 106) intercept data associated with content delivery from content server 106 to a client device associated with the end-user (e.g., computing device 102), and perform appropriate action(s) desired/required by the end-user on behalf thereof without requirement of intervention from content server 106 and an interface (e.g., web browser) associated with the end-user of the client device.

In one or more embodiments, as discussed above, agent 104 may be installed on central server 202 and/or the end-user computing device (e.g., computing device 102). Also, in one or more embodiments, agent 104 may be installed at a number of end-user computing devices on a per-user basis. In one or more embodiments, in all scenarios, all traffic from content server 106 may be redirected through agent 104. In one or more embodiments, the end-user may authorize a browser and/or a Point-of-Presence (POP) router to redirect all traffic through agent 104. Then, in one or more embodiments, the end-user may authorize agent 104 separately to enable addition of “intelligence” to content delivered to the computing device associated therewith.

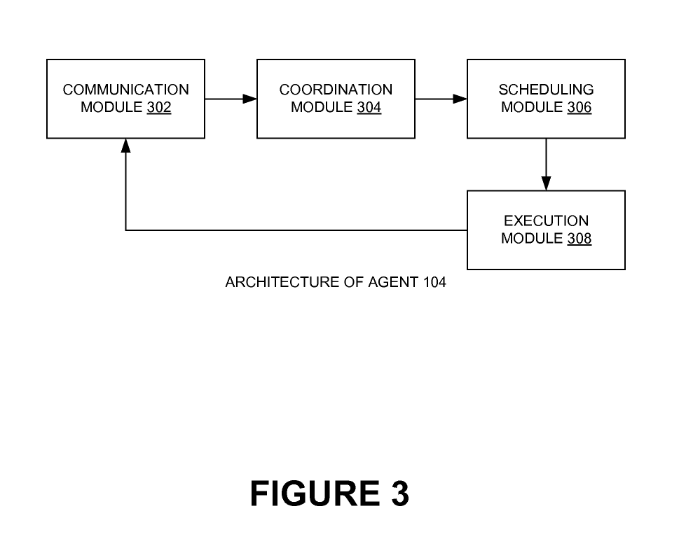

In one or more embodiments, in contrast to browser-dependent codes such as plug-ins and/or browser extensions, “intelligence” to content to be delivered to/from the end-user may be added on a relatively universal basis through agent 104. FIG. 3 shows the architecture of agent 104, according to one or more embodiments. In one or more embodiments, agent 104 may include a communication module 302 configured to interpret requests from the end-user (and/or a system administrator of central server 202). In one or more embodiments, the requests may be associated with tasks to be performed through agent 104. In one or more embodiments, communication module 302 may present a user interface through which tasks to be performed through agent 104 may be entered/selected. Alternately, the end-user or the system administrator may enter a script in the language understood by an interpreter associated with agent 104 to initiate tasks desired.

In one or more embodiments, agent 104 may also include a coordination module 304 configured to coordinate a plan of action associated with the requests through communication module 302. For example, coordination module 304 may organize a list of tasks to be performed based on the interpretation of requests through communication module 302. In one or more embodiments, a scheduling module 306 of agent 104 may order the list of tasks to be performed generated through coordination module 304. For example, the user may first prefer the embedding of a search box within a web-page to be accessed thereby, followed by the search of a particular set of text characters within the web-page. In one or more embodiments, execution module 308 of agent 104 may then execute the tasks in accordance with the order provided through scheduling module 306.

In one or more embodiments, agent 104 may be configured to create/build/update a configuration file that includes parameters (e.g., parameters required by the end-user/system administrator to be updated on the web-page to accessed by the end-user) to be interpreted therethrough. For example, there may be a number of configuration files built/updated/created based on the configuration (e.g., operating system) associated with the end-user computing device. The aforementioned configuration files associated with the end-user(s) may be built upon the initiation of the first instance of execution of desired tasks through execution module 308 on the corresponding computing device(s). Alternately, the system administrator may be configured to create the configuration file(s).

Configuration file(s) may then be periodically updated/generated based on parameters such as platforms utilized to execute the desired tasks. In one or more embodiments, agent 104 (or, execution module 308) may also have a data store/database (not shown) associated therewith to store preferences associated with the end-user(s). It is obvious that the HTTP protocol is portable across most operating systems and/or browsers. However, in one or more embodiments, in the enterprise scenario, central server 202, on which agent 104 is configured to execute, may communicate with end-user computing devices through a proprietary protocol. In one or more embodiments, in order to accommodate communication through the proprietary protocol, an appropriate Application Programming Interface (API) may be provided to the end-user (e.g., a programmer, system administrator) through agent 104 to enable the end-user to implement an appropriate handler for the proprietary protocol.

In an example JAVA implementation, a custom java.net URLStreamHandler class and a java.net URLConnection may be defined. The URLStreamHandler class may then be appropriately named to handle the proprietary protocol discussed above. The proprietary protocol may then be placed in a list of protocols supported. The binary file(s) generated and associated with agent 104 may have the capability to execute on a number of computing platforms. When the binary file(s) are generated, indicators associated with the target computing platform(s) may be included in the set of instructions (e.g., program) written for the desired functionalities. A lot of the functionality associated with the code may remain supported across multiple platforms. However, in order to address platform-specific requirements, a number of libraries may be provided to enable compatibility.

In one or more embodiments, once agent 104 is “live” (i.e., executing on central server 102 and/or the end-user computing device (e.g., computing device 102)), content server 106 may receive and/or respond to requests associated with performing appropriate action(s) on behalf of the end-user. In other words, the end-user browser (or, other elements) may then appropriately communicate with content server 106. In one or more embodiments, content server 106 may accept requests commonly across multiple platforms through sockets (e.g., UNIX sockets, Windows® sockets, Mac™ sockets). In one or more embodiments, the networking library provided through the operating system may be abstracted through an appropriate programming language (e.g., JAVA™).

In the example JAVA™ implementation, a JAVA™ networking socket may be opened on a port, which provides a channel for establishment of a connection between applications through binding the socket with an identifier. When the end-user/system administrator installs agent 104 on a computing device associated therewith, the end-user/system administrator may appropriately update the configuration file(s) to configure a browser to communicate with agent 104. The aforementioned configuration may be associated with the establishment of the connection between agent 104 and the end-user browser. Through provision of a proxy configuration Uniform Resource Locator (URL) file to the browser, the browser settings may be modified such that whenever the end-user computing device connects to the Internet, communication from content server 106 is routed through agent 104 at central server 202 or at the end-user computing device. The aforementioned processes occur with the consent of the end-user, who may be prompted with regard to the modification of the browser settings.

Thus, in one or more embodiments, in contrast to a web proxy that merely acts as a forwarding agent, the presence of agent 104 may enable processing (or, analysis) of incoming data from content server 106/outgoing data to content server 106 in a detailed manner that enables “intelligent” actions to be performed. The aforementioned “intelligent” actions may open up several possibilities/instances of content delivery.

In yet another example scenario, the end-user may configure agent 104 to block all video content prior to the arrival thereof at the end-user computing device or to replace video content with a still image at the end-user computing device. Thus, in contrast to disabling video rendered on a web page at the end-user computing device through the browser thereat, agent 104 may automatically disable video content prior to the arrival thereof at the end-user computing device.

In one or more embodiments, agent 104 may be installed at central server 202, where a lot of incoming traffic (or, content therein) may be blocked prior to arriving at an end-user computing device. Therefore, in one or more embodiments, end-users may pay for utilizing services associated with agent 104 at central server 202 through a subscription. For example, a service provider may install agent 104 at central server 202 associated therewith. As agent 104 provides content blocking, the end-users may subscribe to a low-bandwidth Internet service, with the costs associated with the content blocking (or, services of agent 104) being less than the difference in the cost(s) between a high-bandwidth Internet service and the low-bandwidth Internet service. As the service provider may pick up the charges associated with the higher bandwidth of traffic at central server 202, the end-users may benefit through the content blocking services.

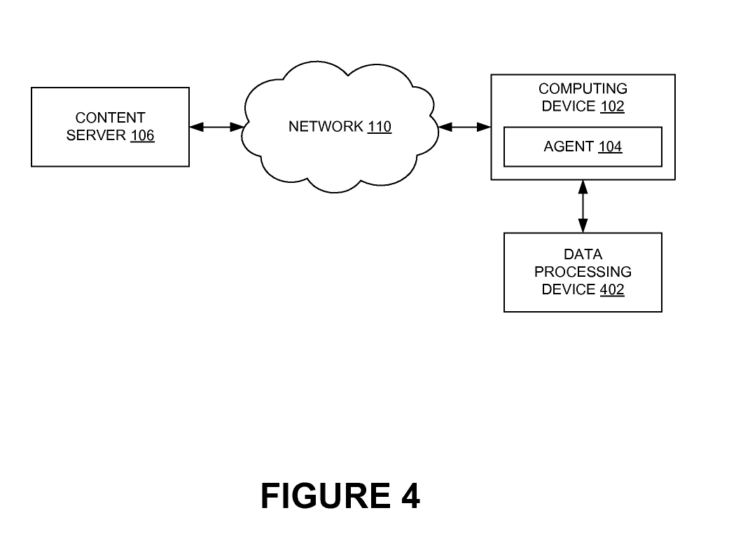

Thus, in one or more embodiments, content blocking/“intelligent” content delivery may be provided as a service, and may be combined with other service agreements between the service provider and the end-user. FIG. 4 shows a scenario where content from a data processing device 402 (e.g., mobile phone) is processed through agent 104 installed on computing device 102. For example, data processing device 402 may be configured to communicate with computing device 102 through infrared, Bluetooth®, wireless means etc. Here, in one or more embodiments, the “intelligent” actions performed through agent 104 may be dependent on the data obtained from data processing device 402 (and/or computing device 102).

In an example scenario involving a mobile phone as data processing device 402, Windows Media™ Video (WMV) files may be required to be converted to a 3gp format in order to be rendered on the mobile phone. Here, agent 104 at computing device 102 may initiate (e.g., through the user of computing device 102) the download of the appropriate service through the Internet to start the conversion. Agent 104 may also load the package associated with the conversion service in the memory of computing device 102. Alternately, agent 104 may be packaged with the appropriate conversion service. Thus, WMV files downloaded through the mobile phone may be configured through the end-user to be routed through computing device 102 in order to be converted to the appropriate format required for rendering on the mobile phone.

Alternately, data processing device 402 may also include agent 104 (or, an instantiation of agent 104) executing thereon. Thus, the download of the appropriate conversion service may be initiated through agent 104 executing on data processing device 402. Agent 104 on data processing device 402 may also be provided the capability to download the appropriate conversion service onto data processing device 402 and perform the conversion thereon.

In another example scenario involving the mobile phone as data processing device 402, the end-user may be reading a web-page, and may want to bookmark the web-page. Instead of bookmarking the web-page through the browser, agent 104 installed on computing device 102 associated with the end-user may be configured (e.g., by the end-user) to save the bookmark (and/or update the bookmark(s)) on the mobile phone associated with the end-user. The end-user may be at work and the aforementioned bookmark may be work-related. The end-user may then go home and access his/her personal computer, which may also have agent 104 installed thereon.

While accessing a web-page at home, the “embedded” bookmark action may also be active through agent 104 installed on the personal computer. There may be a drop down menu in the browser analogous to “show all past bookmarks.” When the “show all past bookmarks” option is selected, agent 104 may communicate with the mobile phone (e.g., a mobile phone that executes agent 104 thereon) to pull up all the past bookmarks (e.g., by showing all past bookmarks in a drop down menu). The aforementioned function may be performed independent of content server 106, and may be performed transparently without writing a browser extension.

Thus, in one or more embodiments, data processing device 402 may also be configured to perform computations/processing on behalf of the end-user associated with computing device 102 through agent 104 executing on data processing device 402 and/or computing device 102, without the requirement of intervention from content server 106 and, for example, a web-browser.

Although scenarios involving HTTP sessions have been discussed above, it is to be noted that other non-HTTP functions are within the scope of the exemplary embodiments. In yet another example scenario involving the mobile phone, the end-user may authorize agent 104 at computing device 102 to encrypt unencrypted file(s) (e.g., downloaded to the mobile phone from content server 106) with a private key and transmit the encrypted file(s) to the mobile phone. The private key, for example, may be stored in the mobile phone. Agent 104 may communicate with the mobile phone to obtain the private key and then encrypt the file(s) prior to the transmission to the mobile phone.

Alternately, again, an instantiation of agent 104 may be executing on the mobile phone. The encryption of files downloaded to computing device 102 and/or the mobile phone may be initiated and/or performed through agent 104 executing on the mobile phone. Files encrypted at the mobile phone may be transmitted to computing device 102, where the files can be decrypted through a public key.

It is obvious that exemplary embodiments are not limited to the above-mentioned scenarios. For example, form fields in web-pages with HTML forms may be saved. The aforementioned save process, when initiated by the end-user, may or may not initiate a communication with the agent or an external web service. The save process may communicate the fields typed by the end-user to agent 104 to be stored in a data store associated with a central server (e.g., central server 202) or a data processing device (e.g., computing device 102, data processing device 402) controlled through the end-user.

In order to perform a function such as a “fetch site ranking,” agent 104 may be configured to communicate directly with an external web service to fetch the global website traffic ranking for the domain the website is served under. In one or more embodiments, actions performed through agent 104 may not always require explicit action from the end-user. For example, the end-user may configure agent 104 to intercept certain type(s) of web-pages and automatically perform actions on behalf thereof. As discussed above, the end-user may configure agent 104 to identify web-pages that are login forms using heuristics and/or through statically defining a list of URLs. The list of URLs may be user-provided or provided through an external service provider. Upon identifying the aforementioned web-pages, agent 104 may be configured to auto-fill the username and the password fields before submission to the originating web service for authentication. The aforementioned auto-fill and the submission process may occur without the intervention of the end-user.

In one or more embodiments, the end-user may also authorize agent 104 to collect data relevant (e.g., per-day byte transfer-in and transfer-out) thereto. In one or more embodiments, the aforementioned data set collected may be utilized in providing context for subsequent “action embedding” through agent 104. For example, if the end-user has surpassed a daily download limit thereof, agent 104 may be authorized (e.g., through the end-user) to block video elements in the web-page(s) accessed by the end-user to save on data transfer.

In one or more embodiments, the protocol for communication between the end-user browser and agent 104 may not be required to be the same as the protocol for communication between agent 104 and the external web-service (or, to generalize, the external content delivery service). In one or more embodiments, agent 104 may communicate with the end-user browser through a protocol that is entirely different from the protocol used for communication between agent 104 and the web-service (e.g., serving web-pages, web applications). For example, agent 104 may intercept an HTTPS connection with a banking web-page, and may communicate over HTTP when transmitting data to the end-user. This is in direct contrast to the definition of a web-proxy that retains the same protocol when intercepting communication between the end-user browser and the web-service. Agent 104 may, therefore, be configured to handle both secure and non-secure communication protocols.

In one or more embodiments, whether agent 104 is installed on a number of end-user computing devices on a per-user basis or hosted centrally (e.g., on central server 202) for a group of end-users, agent 104 may be configured as frequently as desired/required by the end-users. In other words, the end-users may configure agent 104 with own settings thereof and/or may authorize agent 104 to perform actions (e.g., on web-pages) exclusive thereto. In one example embodiment, the end-users may also register for additional service(s) provided through agent 104 that affect a list of action(s) associated with the web-pages to be accessed thereby and/or the result of the execution of the aforementioned action(s).

Although the example user-interface associated with the agent (e.g., agent 104) discussed above is a web-browser, the user-interface can also be a custom browser to handle the proprietary protocol between the client device and the agent and/or a native operating system application. Example of a native operating system application may be a default web-browser-like application that is packaged with the operating system associated with the appropriate computing device/data processing device. In one or more embodiments, the user of the client device may then configure the agent (e.g., agent 104) to perform the action on behalf thereof, through modifying a setting associated with the aforementioned user-interface(s), a native operating system and/or the agent to enable interaction between the browser and the agent or agent specific settings accessible via the same browser.

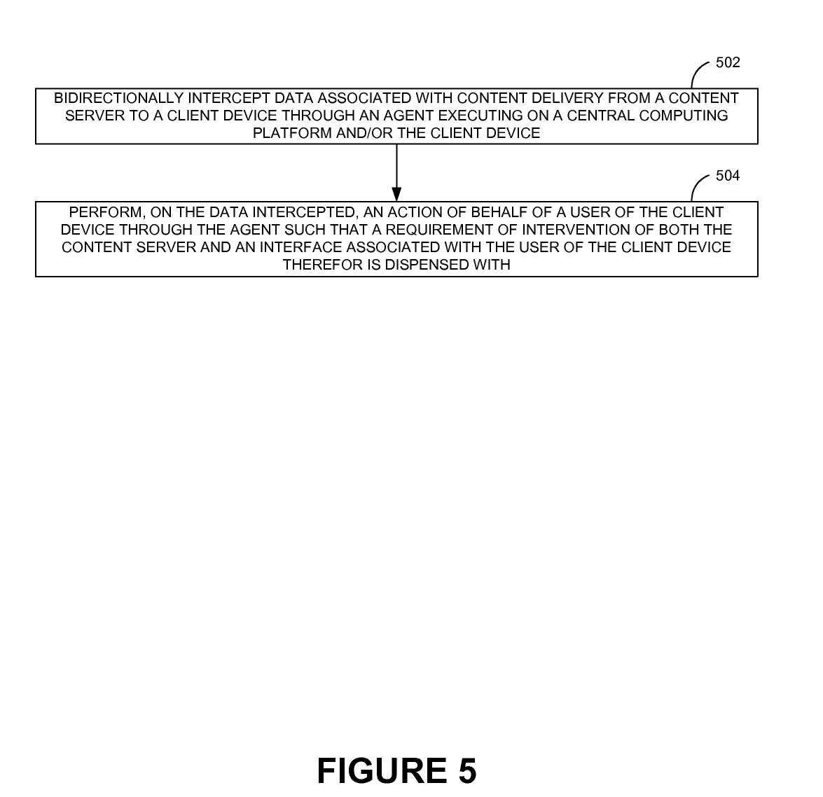

FIG. 5 is a process flow diagram detailing the operations involved in a method of intelligent content delivery, according to one or more embodiments. In one or more embodiments, operation 502 may involve bidirectionally intercepting data associated with content delivery from a content server 106 to a client device (e.g., computing device 102) through an agent 104 executing on a central computing platform (e.g., central server 202) and/or the client device. In one or more embodiments, agent 104 may be capable of handling both secure and non-secure communication protocols. In one or more embodiments, operation 504 may then involve performing, on the data intercepted, an action on behalf of a user of the client device through agent 104 such that a requirement of intervention of both content server 106 and an interface associated with the user of the client device therefor is dispensed with.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium).

In addition, it will be appreciated that the various operations, processes, and methods disclosed herein may be embodied in a machine-readable medium and/or a machine accessible medium compatible with a data processing system (e.g., a computer device), and may be performed in any order (e.g., including using means for achieving the various operations). Accordingly, the specification and drawings are to be regarded in an illustrative rather than a restrictive sense.

What is claimed is:

1. A method comprising:
bidirectionally intercepting data associated with content delivery from a content server to a client device through an agent executing on at least one of a central computing platform and the client device, the agent being capable of handling both secure and non-secure communication protocols; and
performing, on the data intercepted, an action on behalf of a user of the client device through the agent such that a requirement of intervention of both the content server and an interface associated with the user of the client device therefor is dispensed with.

2. The method of claim 1, comprising configuring the agent through the user of the client device to perform the action on behalf thereof.

3. The method of claim 2, further comprising one of subsequently initiating a communication with at least one of the agent and an external content delivery service and subsequently initiating a communication independent of the agent and the external content delivery service upon configuring the agent to perform the action on behalf of the user.

4. The method of claim 1, further comprising performing an action on data associated with an external data processing device through the performance of the action through the agent, the external data processing device being coupled to the client device, the external data processing device also being capable of executing one of the agent and an instantiation thereof thereon, the agent executing on at least one of the external data processing device and the client device being configured to perform the action on at least one of the data associated with the external data processing device and the data intercepted at the client device, and the external data processing device also being configured to be capable of performing processing associated with the data intercepted at the client device through the agent executing on the at least one of the external data processing device and the client device.

5. The method of claim 1,
wherein the client device and the content server are coupled through a computer network, and
wherein when the agent is executing on the central computing platform, the client device, the central computing platform and the content server are also coupled through the computer network.

6. The method of claim 1, wherein when the central computing platform and the computing device communicate through a proprietary protocol, the method further comprises:
providing an Application Programming Interface (API) through the agent to enable at least one of the user of the client device and a system administrator thereof to implement an appropriate handler for the proprietary protocol.

7. The method of claim 1, wherein performing the action on behalf of the user of the client device through the agent further comprises:
authorizing the agent to collect data relevant to the user; and
performing a subsequent action based on a context provided through the collected data relevant to the user.

8. The method of claim 3, wherein a protocol of communication between the interface associated with the user of the client device and the agent is different from a protocol of communication between the agent and the external content delivery service.

9. The method of claim 1, wherein when there is a plurality of client devices having one of the agent installed thereon on a per-user basis and the agent hosted centrally on the central computing platform, performing the action on behalf of the user of the client device through the agent further comprises:
providing, through the agent, an additional service configured to affect at least one of the action on the data intercepted and a result of execution of the action; and
subscribing to the additional service through the user of the client device.

10. A medium, readable through at least one of a computing device and a central computing platform and including instructions embodied therein that are executable on the at least one of the computing device and the central computing platform, comprising:
instructions relating to bidirectionally intercepting data associated with content delivery from a content server to the client device; and
instructions associated with performing, on the data intercepted, an action on behalf of a user of the client device such that a requirement of intervention of both the content server and an interface associated with the user of the client device therefor is dispensed with,
wherein the instructions relating to intercepting the data associated with content delivery and the instructions relating to the performance of the action are configured to handle both secure and non-secure communication protocols.

11. The medium of claim 10, wherein the medium is one of a memory, a Compact Disc (CD), a Digital Video Disc (DVD), a Blu-ray™ disc, a floppy disk and a diskette.

12. A system comprising:
a client device;
a computer network;
a content server configured to deliver content to the client device through the computer network; and
an agent configured to:
bidirectionally intercept data associated with the content delivery from the content server to the client device through the computer network, and
perform an action on behalf of a user of the client device such that a requirement of both the content server and an interface associated with the user of the client device therefor is dispensed with,
wherein the agent is capable of handling both secure and non-secure communication protocols.

13. The system of claim 12, wherein at least one of:
the agent is configured to execute on the client device, and
the system further comprises a central computing platform configured to execute the agent thereon, the central computing platform, the client device and the content server being coupled through the computer network.

14. The system of claim 12, wherein the user of the client device configures the agent to perform the action on behalf thereof.

15. The system of claim 14, wherein the configuring of the agent through the user of the client device is configured to one of subsequently initiate a communication with at least one of the agent and an external content delivery service associated with the content server and subsequently initiate a communication independent of the agent and the external content delivery service.

16. The system of claim 12, further comprising a data processing device on which an action is configured to be performed through the performance of the action through the agent, the data processing device being coupled to the computing device, the data processing device also being capable of executing one of the agent and an instantiation thereof thereon, the agent executing on at least one of the data processing device and the client device being configured to perform the action on at least one of the data associated with the data processing device and the data intercepted at the client device, and the data processing device also being configured to be capable of performing processing associated with the data intercepted at the client device through the agent executing on the at least one of the data processing device and the client device.

17. The system of claim 13, wherein the agent is configured to provide an API to enable at least one of the user of the client device and a system administrator thereof to implement an appropriate handler for a proprietary protocol when the proprietary protocol is used for communication between the central computing platform and the computing device.

18. The system of claim 14,
wherein the interface associated with the user of the client device is at least one of a web browser, a custom browser to handle the proprietary protocol between the client device and the agent and a native operating system application.

19. The system of claim 18,
wherein the user of the client device configures the agent to perform the action on behalf thereof through modifying a setting associated with at least one of the web browser, the custom browser, a native operating system, the native operating system application and the agent.

20. The system of claim 15, wherein a protocol of communication between the interface associated with the user of the client device and the agent is different from a protocol of communication between the agent and the external content delivery service.

21. The system of claim 13, wherein when the system includes a plurality of client devices having one of the agent installed thereon on a per-user basis and the agent hosted centrally on the central computing platform, the agent is further configured to enable:
provision of an additional service configured to affect at least one of the action on the data intercepted and a result of execution of the action; and
subscription to the additional service through the user of the client device.
